(19) United States
(12) Patent Application Publication
(10) Pub. No.: US 2006/0267292 A1
(43) Pub. Date: Nov. 30, 2006

(54) Encoder-equipped sealing device

(76) Inventor: Hironori Yamamoto, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/496,466

(22) Filed: Aug. 1, 2006

Related U.S. Application Data
(63) Continuation of application No. 10/484,166, filed on Jan. 20, 2004.

(30) Foreign Application Priority Data
Jul. 18, 2001 (JP) 2001-217672

(51) Int. Cl. F16J 15/32

(52) U.S. Cl. 277/549

(57) ABSTRACT

An encoder-equipped sealing device includes two seal members arranged to face opposite each other and each having a reinforcing ring with an L-shaped cross section. Each of the reinforcing rings has a cylindrical portion and a flange portion extending from one end of the cylindrical portion in a direction perpendicular to the cylindrical portion. One seal member includes an elastic seal formed in such a manner as to be supported by the reinforcing ring of this seal member, with the elastic seal extending toward the other seal member such that a seal portion is formed between the elastic seal and the other seal member. The other seal member includes an encoder on a side of the flange portion of the other seal member that is opposite a side facing the one seal member. The one seal member includes an elastic element formed in such a manner as to be supported by the flange portion of this seal member. The elastic element is formed on a side of the flange portion of the one seal member that is opposite a side facing the other seal member.

This application is a continuation application of Ser. No. 10/484,166, filed Jan. 20, 2004, which is a National Stage of PCT/JP02/07297, filed Jul. 18, 2002.

### TECHNICAL FIELD

Generally, the present invention relates to an improvement to or in a sealing device with an encoder, that is, an encoder-equipped sealing device. More particularly, the present invention relates to such encoder-equipped sealing device that may be mounted on a bearing unit for supporting a wheel on an automotive vehicle so that the sealing device can seal the bearing unit by isolating an interior thereof from an exterior thereof, wherein the encoder that is incorporated into the encoder-equipped sealing device may be located to face opposite a rotation detecting sensor that responds to the encoder for detecting a number of revolutions of the wheel when the encoder-equipped sealing device is mounted on the bearing unit.

### BACKGROUND ART

The encoder (pulse coder) that is incorporated into the encoder-equipped sealing device that has been described above takes the form of a pulse generator ring that may be mounted on an automotive vehicle wheel in order to flexibly control a device that ensures that the automotive vehicle can run with safety and stability, such as an anti-lock braking system, traction control system, and stability control system. This encoder may be mounted on a hub flange in a suspension system of the automotive vehicle together with a sensor, and is used to detect a number of revolutions for each of the vehicle wheels. Specifically, an encoder that is mounted on each of four wheels, such as front, rear, right and left wheels, may be used in conjunction with the sensor so that it can detect any difference in the number of revolutions between each of the wheels. In response to such difference, the encoder may produce pulses for controlling a drive system or brake system so as to be turned on and off, thereby controlling behavior of the vehicle to ensure that the vehicle can run with stability and safety in case some emergency situations should occur.

Lubricating oil leaks may occur in the bearing unit where the encoder is located to face opposite the sensor for detecting the number of wheel revolutions as described above, and seals are required to avoid such leaks. Most of conventional sealing devices have a construction that includes both the rotation detecting device and sealing device that may be located in a gap or space that is available in the bearing unit.

Typically, the sealing device that has been proposed for recent years provides a rotation detecting function and encoder function, both of which are incorporated integrally within the sealing device, and has been used widely for practical purposes.

By referring now to FIG. 5, a typical example of a conventional encoder-equipped sealing device, generally identified by 101, is described below. As shown in FIG. 5, the sealing device includes two seal members 105, 115 combined together and arranged to face opposite each other, each of which has a reinforcing ring 104, 114 having an L-shaped cross section. Each of the reinforcing rings 104, 114 has a cylindrical portion 102, 112 and a flange portion 103, 113 extending from one end of a respective cylindrical portion 102, 112 in a direction perpendicular to the respective cylindrical portion 102, 112. In such encoder-equipped sealing device 101, at least one of the two seal members 105, 115 (such as 115 in the case shown in FIG. 5) includes an elastic seal 116 that is formed in such a manner as to be supported by the reinforcing ring 114. The elastic seal 116 extends toward the other seal member 105, and seal portions (such as 117, 118, 119 in the case shown in FIG. 5) are formed between the seal member 105 and seal member 115. In one of the two seal members 105, 115 (such as 105 in the case shown in FIG. 5), the flange portion 103 of the reinforcing ring 104 has an encoder 110, which is attached to a side thereof opposite a side on which seal member 115 is located.

It may be seen in FIG. 6 that the encoder-equipped sealing device described above may be mounted on a bearing unit 121 having two elements, such as inner race 123 and outer race 122, rotating relative to each other. With the encoder-equipped sealing device being mounted on the bearing unit, the encoder 110 may be located adjacently a sensor 120 that is disposed to face opposite the encoder so that a number of wheel revolutions can be detected by the sensor responding to pulses from the encoder. In the embodiment shown in FIGS. 5 and 6, it is assumed that the inner race 123 corresponds to a rotational element and the outer race 122 corresponds to a non-rotational element.

Each of the reinforcing rings 104, 114 may be formed from any metal such as iron, stainless steel and the like, and the elastic seal 116 may be formed from any elastic material such as synthetic rubber, elastomer and the like. The elastic seal 116 thus formed may be attached to the reinforcing ring 114 so that it can be supported by the reinforcing ring 114.

In the embodiment shown in FIGS. 5 and 6, it may be seen that the elastic seal 116 is supported by the seal member 115, and is formed so that it can extend toward the seal member 105 and seal portions 117, 118, 119 can be formed between the seal member 115 and seal member 105. Since these seal portions are provided for sealing the bearing unit 121 by isolating an interior thereof from an exterior thereof, it should be noted that it is sufficient that an elastic seal that is formed on at least one of the two seal members and is supported by the reinforcing ring of the one seal member should extend toward the other seal member, and the seal portions should be formed between the two seal members. As an alternative construction, the elastic seal 116 may be supported by the seal member 105 and the seal portions may be formed between the seal member 105 and seal member 115.

It is known that the encoder is usually made of a mixture composed of any elastic material such as synthetic rubber, synthetic resin and the like, and any ferromagnetic material such as ferrite in powdery forms.

The encoder-equipped sealing device that has been completed as described above, including the seal members 105, 115 combined into one unit, may be placed in an appropriate storage area as shown in FIG. 7 until it is finally mounted at an area, such as the bearing unit, which needs to be sealed. When each set of several such encoder-equipped sealing devices are stored, the encoder-equipped sealing devices in each set are placed one over another so that they can be oriented in one particular direction as shown in FIG. 7. This is done for ease of handling or for ease of being set in any machine tool that is used for mounting each encoder-equipped sealing device onto a bearing unit. In the example shown in FIG. 7, two encoder-equipped sealing devices are provided, in which one encoder-equipped sealing device 101 has the seal members 105, 115 combined together and the other encoder-equipped sealing device 201 has seal members 205, 215 combined together, and these sealing devices are placed one over the other such that they can be oriented in one particular direction, with respective encoders 110, 210 of the encoder-equipped sealing devices 101, 201 being located on the right side in FIG. 7.

The magazine, which contains several units, such as two units 101, 201, of the encoder-equipped sealing device placed one over the other such that they can be oriented in one particular direction as described, may be transported or stored with the units in the magazine being tied in a row. Finally, the units may be removed one by one from the magazine, and may be mounted on the bearing unit 121.

It should be noted, however, that when the units 101, 201 are placed one over the other within the magazine as they are tied in a row, the encoders 110, 210 of the respective units 101, 201 produce strong magnetic forces. As the two units 101, 201 are placed adjacently each other within the magazine, the encoder 110 of one unit 101, for example, being located to face opposite flange portion 213 of reinforcing ring 214 of the seal member 215 of the other unit 201 and making contact with the flange portion 213, may be magnetically attached to the flange portion 213 of the other unit 201 under magnetic attraction of the encoder 110. As a result, magnetic cohesion may occur between the two units; that is, the seal portion 105 of the one unit 101 and the seal portion 215 of the other unit 201 may be attached to each other by attracting each other under magnetic action of the encoder 110.

When this occurs, the units 101, 201 within the magazine cannot be removed from the magazine because they may become stuck within the magazine when an attempt is made to remove and mount each of the units 101, 201 onto an area in the bearing unit 121 that needs to be sealed, by using any mechanical device such as a mounting machine. In other words, the mounting machine cannot work well, which may introduce a serious problem of affecting a mounting efficiency of the mounting machine considerably.

In order to prevent the above situation from occurring, one possibility would be to interpose something (not shown) that is thick enough to space the two units 101, 201 apart from each other when the units are placed one over the other within the magazine so that they can be aligned in one particular and same direction. By so doing, however, it would be difficult to handle the units. For this reason, this method had a short life.

In contrast to the prior art encoder-equipped sealing device that has been described above, the present invention provides an encoder-equipped sealing device that has a simple construction, wherein all of serious problems and inconveniences associated with the prior art encoder-equipped sealing device have been eliminated. In accordance with the encoder-equipped sealing device of the present invention, several units of the encoder-equipped sealing device may be placed one over another within a mounting magazine such that these sealing devices are oriented in one particular direction, and when one of these units is removed from the magazine and mounted onto a bearing unit, this can be performed reliably and accurately without causing any handling problems because there is no magnetic cohesion between two adjacent units which would be caused by magnetic attraction of an encoder of one of the two units.

### SUMMARY OF THE INVENTION

The present invention solves the problems associated with the conventional encoder-equipped sealing device that have been mentioned above, by providing the following encoder-equipped sealing device.

An encoder-equipped sealing device provided by the present invention includes two seal members combined together such that they are arranged to face opposite each other, with each of the two seal members including a reinforcing ring with an L-shaped cross section having a cylindrical portion and a flange portion extending from one end of the cylindrical portion in a direction perpendicular to the cylindrical portion. At least one of these two seal members includes an elastic seal formed in such a manner as to be supported by the reinforcing ring of the one seal member, and the elastic seal extends toward the other seal member such that a seal portion is formed between the elastic seal and the other seal member. And, at least one of these two seal members includes an encoder that is attached to a side of the flange portion of the reinforcing ring of the one seal member that is opposite a side facing the other seal member. The other seal member, arranged to face opposite the one seal member including an encoder on the flange portion, includes an elastic element formed in such a manner as to be supported by the flange portion of the reinforcing ring of the other seal member, wherein the elastic element is formed on the side of the flange portion of the reinforcing ring of the other seal member that is opposite the side facing the one seal member including the encoder on its flange portion.

Several units of the encoder-equipped sealing device according to the present invention, such as two units in this case, may be stored in a mounting magazine before they are actually mounted on an area that needs to be sealed, such as a bearing unit. Within the magazine, the two units may be placed one over the other so that they can be oriented in one particular direction as shown in FIG. 3. When the units are placed in the magazine, the encoder of one unit can always be separated by the elastic element of the other unit that is placed adjacently the one unit. In other words, the elastic element may always be placed between the encoder of the one unit and the flange portion of the reinforcing ring of an adjacent unit. Thus, there is no magnetic cohesion between the two units placed one over the other and oriented in one particular direction that would be caused by magnetic attraction of the encoder of one of these two adjacent units. When an attempt is then made to remove one unit from the magazine, that contains the two units placed in such a manner as to be oriented in one particular direction, and then to mount the unit onto a bearing unit, this can be done easily by simply sliding the unit vertically or horizontally with regard to the other unit. Thus, the encoder-equipped sealing device can be mounted with highly improved reliability onto a bearing unit by any mechanical device.

In accordance with a first aspect of the encoder-equipped sealing device according to the present invention, the elastic element formed on and supported by the flange portion of the before described other seal member may be formed to have a thickness that becomes greater from one end toward another end of the flange portion of the before described other seal member. The elastic element thus formed includes a thickened part that can prevent magnetic cohesion from occurring between the two units. It may be seen from FIG. 2 that the elastic element thus formed has a surface that is slanted smoothly and with no undulations from one end of the flange portion toward the other end thereof. Thus, the units that are placed in such a manner as to be oriented in one particular direction within the mounting magazine can be removed easily from the magazine by simply sliding one unit vertically or horizontally with regard to the other unit, and can then be mounted onto the bearing unit. When an attempt is thus made to remove the units in order to mount them on the bearing unit, this can be accomplished easily without causing the units to be stuck or caught by some parts within the magazine.

In accordance with a second aspect of the encoder-equipped sealing device of the present invention, the elastic element formed in such a manner as to be supported by the flange portion of the before described other seal member is provided such that it can cover a side of the flange portion of the before described other seal member that is opposite a side facing the before described one seal member, and has a thickness that becomes greater from one end toward the other end of the flange portion of the before described other seal member, with a forward end of the elastic element having a greater thickness projecting beyond the before described other end of the flange portion of the before described other seal member.

In addition to the function and effect that may be provided by the encoder-equipped sealing device according to the first aspect, the encoder-equipped sealing device according to the second aspect can provide a better sealing capability for a bearing unit because the forward end is formed to have a greatest thickness and project beyond the other end of the flange portion when the encoder-equipped sealing device is mounted on the bearing unit.

### BRIEF DESCRIPTION OF THE DRAWINGS

FIG. 1 represents a cross sectional diagram for one example of an encoder-equipped sealing device according to the present invention, with some non-essential parts or elements not being shown;

FIG. 2 represents a cross sectional diagram for another example of the encoder-equipped sealing device according to the present invention, with some non-essential parts or elements not being shown;

FIG. 3 represents a cross sectional diagram that illustrates how two units of the inventive encoder-equipped sealing device shown in FIG. 2 are placed one over the other so that they are oriented in a particular direction, with some non-essential parts or elements not being shown;

FIG. 4 represents a cross sectional diagram for a further example of the inventive encoder-equipped sealing device according to the present invention, with some non-essential parts or elements not being shown;

FIG. 5 represents a cross sectional diagram for one example of a prior art encoder-equipped sealing device, with some non-essential parts or elements not being shown;

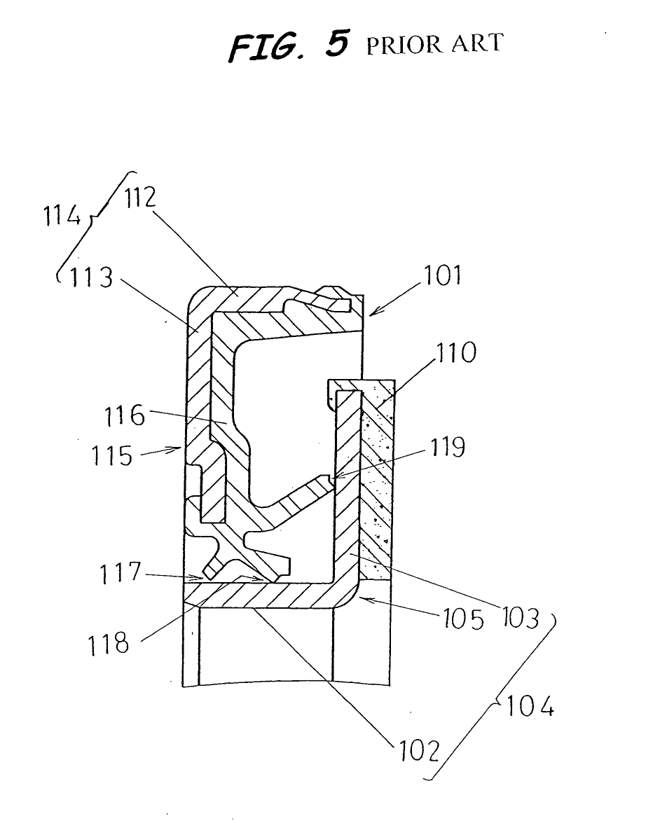

FIG. 6 represents a cross sectional diagram that illustrates how the prior art encoder-equipped sealing device shown in FIG. 5 is mounted within a bearing unit, with some non-essential parts or elements not being shown; and

FIG. 7 represents a cross sectional diagram that illustrates how two units of the prior art encoder-equipped sealing device shown in FIG. 5 are placed one over the other so that they are oriented in a particular direction, with some non-essential parts or elements not being shown.

### DETAILED DESCRIPTION OF THE PREFERRED EMBODIMENTS

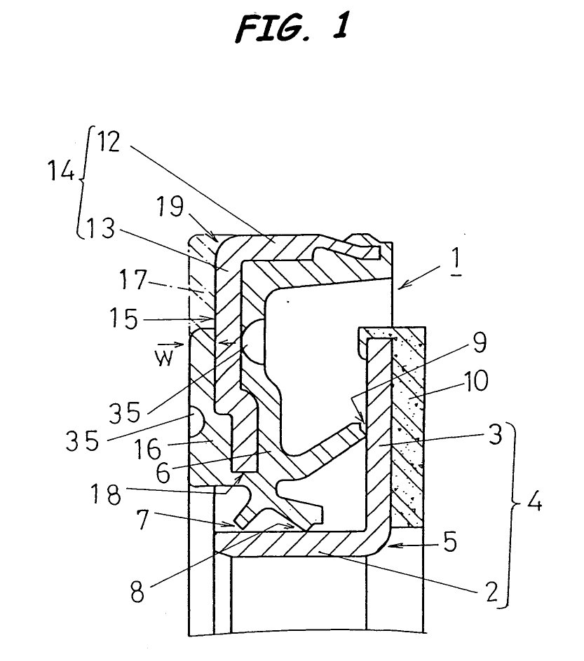

Referring now to FIG. 1, an encoder-equipped sealing device according to one embodiment of the present invention, generally identified by 1, includes two seal members 5, 15 combined together such that they are arranged to face opposite each other.

Specifically, the seal member 5 includes a reinforcing ring 4 with an L-shaped cross section having a cylindrical portion 2 and a flange portion 3 extending from one end of the cylindrical portion 2 in a direction perpendicular to the cylindrical portion 2.

Similarly, the seal member 15 includes a reinforcing ring 14 with an L-shaped cross section having a cylindrical portion 12 and a flange portion 13 extending from one end of the cylindrical portion 12 in a direction perpendicular to the cylindrical portion 12.

The seal member 15 further includes an elastic seal 6 formed such that it can be supported by the reinforcing ring 14. In the encoder-equipped sealing device 1 that has been completed as described above by combining these two seal members 5, 15 together such that they can be arranged to face opposite each other as shown in FIG. 1, the elastic seal 6 of the seal element 15 can extend toward the seal member 5, and seal portions 7, 8, 9 can be formed between the elastic seal 6 and seal member 5.

Each of the reinforcing rings 4, 14 may be formed from any metal such as iron, stainless steel and the like, as is known in the relevant art. The elastic seal 6 may be formed from any of elastic material such as synthetic rubber, elastomer and the like, as is known in the relevant art. The elastic seal 6 may be attached to the reinforcing ring 14 by using any of processes that are known in the relevant art so that the elastic seal can be supported by the reinforcing ring 14.

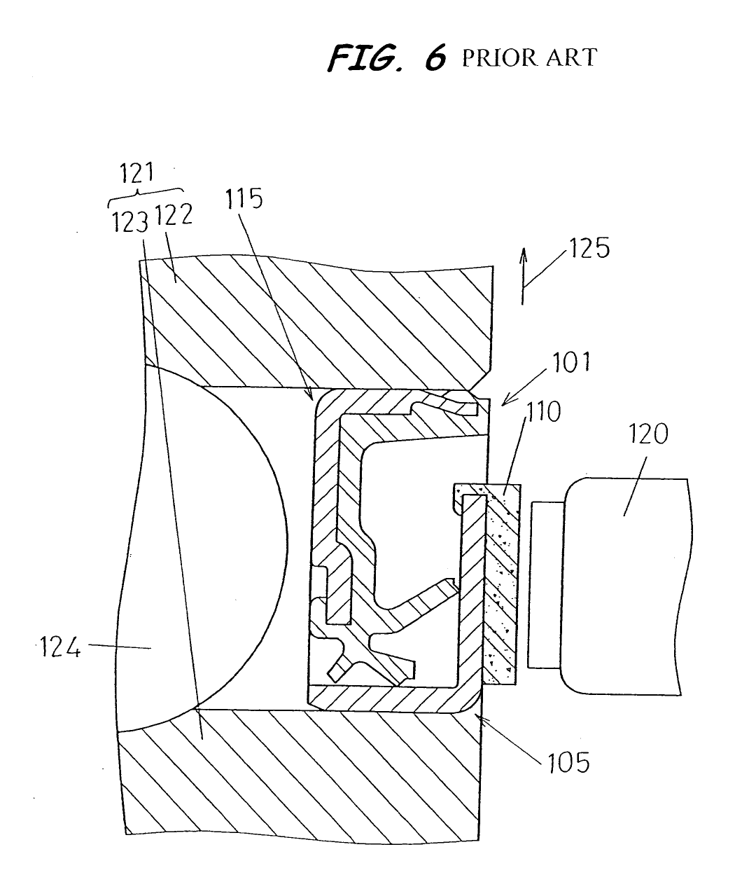

In the embodiment shown in FIG. 1, it may be seen that the elastic seal 6 is supported by the seal member 15, and extends toward the seal member 5 such that seal portions 7, 8, 9 can be formed in a contacting or non-contacting manner between the seal member 15 and the seal member 5. It may be understood from the above description concerning the prior art encoder-equipped sealing device 101 that the seal portions 7, 8, 9 are provided to seal a bearing unit by isolating an interior thereof from an exterior thereof, when the encoder-equipped sealing device 1 is mounted on the bearing unit as shown in FIG. 6. It is therefore sufficient that the elastic seal 6 should only be provided on at least one of the seal members 5, 15 combined together. In one specific form, the elastic seal 6 thus formed on the one seal member 5 or 15, such that it can be supported by the reinforcing ring of the one seal member, may be extended toward the other seal member 15 or 5, and the seal portions may be formed in the contacting or non-contacting manner between the two seal members 5, 15. In another specific form, the elastic seal 6 may be supported by the seal member 5 and may be extended toward the seal member 15 such that the seal portions can be formed in the contacting or non-contacting manner between the seal members 5, 15, although this is not shown.

In the encoder-equipped sealing device 1 according to the present invention, it is seen from FIG. 1 that an encoder 10 is attached to a side of the flange portion 3 on at least one of the seal members 5, 15 (the seal member 5 in the embodiment shown in FIG. 1) opposite a side on which the other seal member, 15 in this case, is located.

As it is known in the relevant art, this encoder 10 may be formed from a mixture composed of any of elastic material such as synthetic rubber, synthetic resin and the like, and any of ferromagnetic materials such as ferrite in powdery forms. For example, the encoder may be molded into an annular magnetic ring from a mixture of the elastic rubber material and ferromagnetic materials such as ferrite in powdery forms by using any vulcanizing process, and may then be magnetized so that S polarity and N polarity can appear alternately in a circumferential direction. In its one form, the encoder 10 may be formed separately, and then may be attached to a particular lateral side of the flange portion 3 as described above and shown in FIG. 1. In its alternative form, the encoder 10 may be molded together with the flange portion 3 of the reinforcing ring 4 by performing the vulcanizing process so that the encoder can be provided on the particular side of the flange portion.

In the encoder-equipped sealing device 1 according to the present invention, the seal member on which the encoder 10 is not provided, that is, the seal member 15 that is located opposite the seal member 5 to which the encoder 10 is attached via the flange portion 3, further includes an elastic element 16 formed on a side of the flange portion 13 opposite the side on which the seal member 5 is located, such that the elastic element 16 can be supported by the flange portion 13.

As is known in the relevant art and similarly to the elastic seal 6, the elastic element 16 may be formed from any of elastic materials such as synthetic rubber, elastomer and the like, and may be attached to the flange portion 13 of the reinforcing ring 14 by using any vulcanizing process so that the elastic element can be supported by the flange portion 13 of the reinforcing ring 14. It should be noted that because the elastic element 16 and elastic seal 6 may be formed from the same materials, the elastic element 16 may be formed together with the elastic seal 6 that is formed on the reinforcing ring 14 so that it can be supported by the reinforcing ring 14.

In the embodiment shown in FIG. 1, the elastic element 16 is formed into a certain thickness (W) on a side of the flange portion 13 on which the elastic element 16 is provided (left side of the flange portion 13 in FIG. 1).

It has been described that several units of the encoder-equipped sealing device 1, such as two units in this case, may be stored in a mounting magazine such that they can be oriented in one particular direction, until they are actually mounted onto a bearing unit. As the elastic element 16 is interposed between two units placed adjacently each other within the magazine, the thickness (W) should be sufficient to prevent any magnetic cohesion between these two units that would otherwise be caused by magnetic attraction of the encoder 10 of one of the two units.

The elastic element 16 should preferably have thickness (W) of at least 0.7 mm, although it may depend upon magnetic strength of the encoder 10.

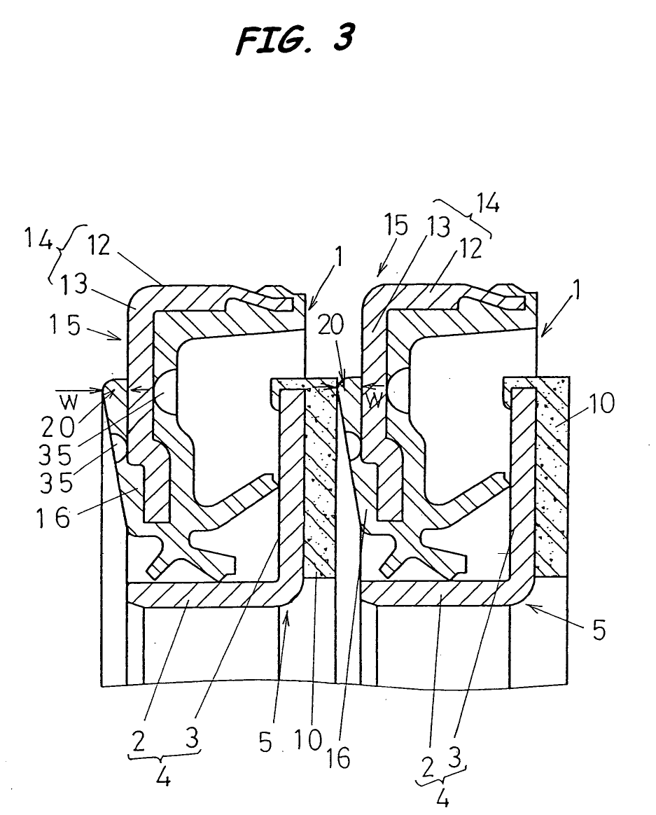

When the two units of the encoder-equipped sealing device 1 are stored within the magazine such that they can be oriented in one particular direction as shown in FIG. 3, before they are actually mounted onto a bearing unit, the elastic element 16 on one unit has its rear side (left side in FIG. 1) that engages a front side of the encoder 10 on the other unit (right side in FIG. 1). Thus, when the elastic element 16 is formed to extend from one end 18 to another end 19 of the flange portion 13, the elastic element 16 should have a length that corresponds to a height (vertical height in FIG. 1) of the encoder 10 as shown in FIG. 1. As a variation of the elastic element 16, an elastic element 17 may be provided such that it extends over an entire left side of the flange portion 13.

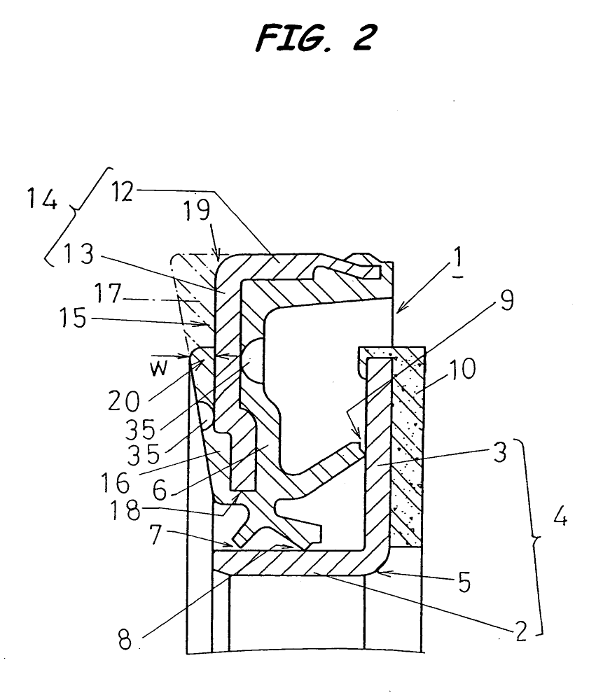

FIG. 2 represents another embodiment of the present invention.

An encoder-equipped sealing device according to a second embodiment contains parts or elements that are similar to those in the preceding embodiment shown in FIG. 1, and these similar parts or elements are given similar reference numerals. These parts or elements are not described further in order to avoid duplication.

Encoder-equipped sealing device 1 in accordance with the embodiment shown in FIG. 2 differs from the encoder-equipped sealing device in accordance with the embodiment shown in FIG. 1 in that elastic element 16, formed such that it can be supported by flange portion 13 of seal member 15, has a thickness that becomes gradually greater from one end 18 toward another end 19 of the flange portion 13 of the seal member 15.

In the embodiment shown in FIG. 2, thickness (W) of a part 20 that is of a greatest thickness should preferably be equal to at least 0.7 mm, which may depend on magnetic strength of encoder 10, as in the preceding embodiment shown in FIG. 1.

The elastic element 16 may be formed such that its thickness becomes gradually greater, starting at one end 18 of the flange portion 13 toward the part 20 having the greatest thickness, and such that the elastic element 16 can have a smooth, that is, non-undulating slanted surface.

In the embodiment shown in FIG. 2, elastic element 17 may also be formed as shown by dot-dash lines such that it can have a length sufficient to cover a lateral side (left side) of the flange portion 13 in its entirety. It should be noted, however, that since a gap that would exist between two units of the encoder-equipped sealing device, that is, between the encoder 10 of one unit and the flange portion 13 of the other unit when the two units are stored within a magazine such that they can be placed adjacently each other and can be oriented in one particular direction, before they are actually mounted onto a bearing unit should be restricted by the part 20 of the thickness (W) that is the greatest, this thickness should preferably be equal to at least 0.7 mm as described before.

Although this is not shown, the elastic element 16 may be formed to have a thickness that becomes greater from one end 19 of the flange portion 13 toward the other end 18 of the flange portion 13, or the elastic element 16 may be formed to have a thickness that becomes greater from one end 19 of the flange portion 13 toward the other end 18 of the flange portion 13 and such that the elastic element 16 has a length sufficient to cover an entire left side of the flange portion 13.

The embodiment in which the elastic element is shown in dot-dash lines 17, as well as the embodiment in which no such elastic element is shown, should be understood to be encompassed within the concept of the invention.

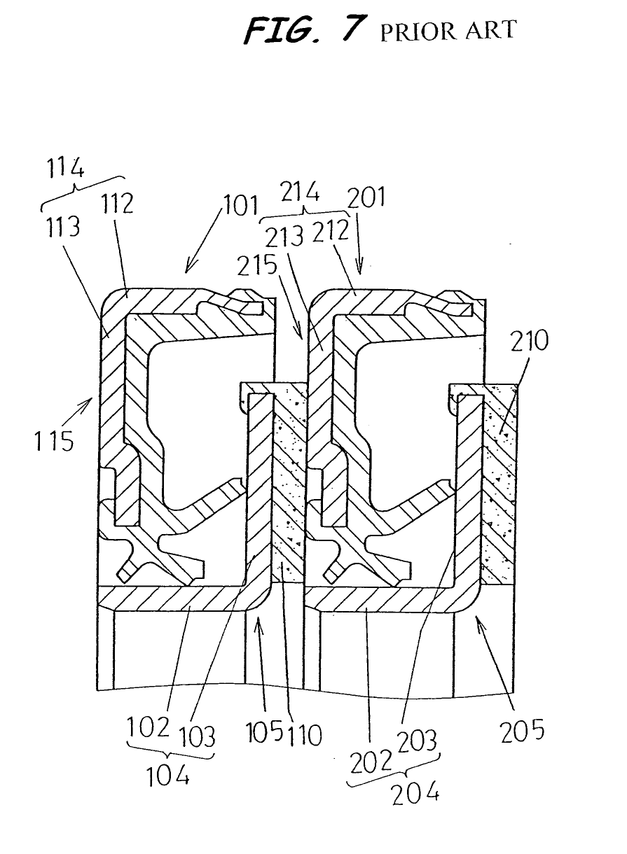

FIG. 3 corresponds to FIG. 7 in which an encoder-equipped sealing device according to the prior art is shown, and illustrates how two units 1, 1 of the encoder-equipped sealing device according to the present invention are placed adjacently each other within a magazine so that they can be oriented in one particular direction, before they are actually mounted onto bearing unit 121.

When the two units 1, 1 of the encoder-equipped sealing device, with each unit having the encoder 10 previously magnetized, are placed one over the other as shown in FIG. 3, the encoder 10 of one unit 1 that is located on the left side in FIG. 3 has its front side engaged by the elastic element 16 of the other unit 1 that is located adjacently the one unit. It may be seen from FIG. 3 that the elastic element 16 exists between the encoder 10 of the one unit 1 located on the left side and metallic flange portion 13 of the other unit 1 that is located on the right side, and the encoder 10 is spaced away from the flange portion 13 by a distance that corresponds to thickness (W). Thus, magnetic forces emitted from the encoder 10 of the one unit 1 (left) can be weakened before they can reach the metallic flange portion 13 of the other unit 1 (right). By placing the metallic flange portion 13 of the other unit 1 (right) out of range of the magnetic forces of the encoder 10 on the left unit 1, the two units can easily be separated from each other.

In the embodiment of the encoder-equipped sealing device 1 shown in FIG. 2, the elastic element 16 is formed to have a thickness that becomes gradually greater from one end 18 of the flange portion 13 toward the other end 19. When the two units 1, 1 are placed one over the other adjacently each other within the magazine and an attempt is then made to separate these two units from each other by sliding one unit relative to the other unit vertically or horizontally, the one unit can be removed from the other unit without causing the one unit to be caught or engaged by the encoder 10 of the other unit or other parts of the other unit because the elastic element 16 is formed to have a thickness that becomes gradually greater from one end 18 of the flange portion 13 toward the other end 19 of the flange portion 13.

When the two units 1, 1 are placed one over the other within the magazine such that they can be oriented in one particular direction as shown in FIG. 3, and when an attempt is made to remove one unit from the magazine so that the one unit can be mounted onto a bearing unit of an automotive vehicle by using any appropriate mounting device, the part 20 of the elastic element 16 having the greatest thickness should preferably be provided at a height that corresponds to a top end of the encoder 10 as shown in FIGS. 2 and 3 in order to permit the one unit to be removed without being caught or engaged by the encoder or other parts of the other unit.

As shown in FIGS. 2 and 3, the part 20 of the elastic element 16 that has the greatest thickness should be formed at the top end of the encoder 10, or more specifically, at a position that corresponds to a radial outer diameter as indicated by an arrow 125 in FIG. 7, and the elastic element 16 should be formed to have a thickness that becomes gradually greater from the end 18 of the flange portion 13 toward the part 20 that has the greatest thickness, and to have a smooth slanted surface. In this way, an attempt to remove one unit from the magazine can be made effectively without causing the one unit to be caught or engaged by the encoder 10 or other parts of the other unit.

When the seal member 15 is molded as part of the encoder-equipped sealing device by using a metal mold, in some cases, a roulette working process may be performed for forming small ridges or bumps that may support the metallic flange portion 13 by engaging its surface, thereby securing the metallic flange portion 13 to a correct position within the metal mold. In FIGS. 1 through 3, a part shown by 35 represents ridges or bumps formed during a roulette working process.

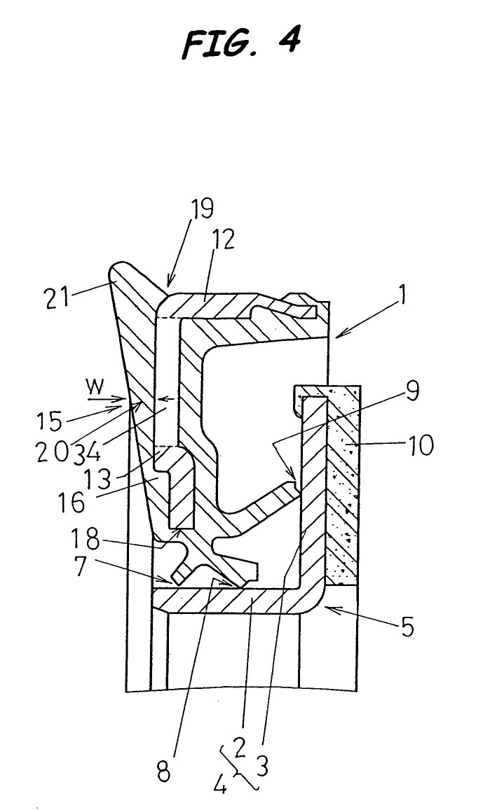

FIG. 4 represents another embodiment of the present invention.

An encoder-equipped sealing device according to this embodiment contains parts or elements that are similar to those in the embodiment shown in FIG. 1. These similar parts or elements are given similar reference numerals, and are not described further here to avoid duplication.

In encoder-equipped sealing device 1 shown in FIG. 4, elastic element 16 that is formed in such a manner as to be supported by flange portion 13 of seal member 15 is provided on a side (left side in FIG. 4) of the flange portion 13 of the seal member 15 opposite the side on which seal member 5 is located, so that the elastic element can cover the flange portion 13 in its entirety. The elastic element 16 is also formed to have a thickness that becomes greater from one end 18 of the flange portion 13 toward another end 19 of the flange portion 13, with a forward end 21 of the elastic element 16 being formed to have a greatest thickness and projecting outwardly from the other end 19 of the flange portion 13.

In accordance with the embodiment shown in FIG. 4, when the encoder-equipped sealing device 1 is mounted on bearing unit 121 as shown in FIG. 6, the forward end 21 formed to have the greatest thickness and projecting outwardly from the other end 19 of the flange portion 13 can provide excellent sealing for the bearing unit 121.

More specifically, the forward end 21 formed to have the greatest thickness can act as a projecting ring having elasticity that permits the ring to extend beyond an outer diameter of the flange portion 13, as viewed in a radial direction shown by arrow 125 in FIG. 6.

The forward end 21 includes part 20 of thickness (W), that is the greatest thickness, just as in FIGS. 1 and 2, and the part 20 becomes gradually greater in a radial outward direction as shown in FIG. 4.

As the elastic element 16 has its forward end 21 formed to have the thickness that is gradually increasing, which increases a mass of the elastic element 16, the elastic element 16 can provide a strong repelling power that causes its forward end 21 to make close contact with a circumferential surface of outer race 122 of the bearing unit 121, when the encoder-equipped sealing device 1 is actually mounted on the bearing unit 121 as shown in FIG. 6. Thus, the bearing unit 121 can be sealed perfectly.

In the encoder-equipped sealing device according to the embodiment shown in FIG. 4, the flange portion 13 of the seal member 15 may have cutouts 34 as indicated by dot lines, such as slits or vent holes, which are provided at regular intervals around its circumference.

These cutouts 34 may be provided for allowing some of a thickened part of the elastic element 16 to flow into the cutouts 34, when the encoder-equipped sealing device 1 is mounted on the bearing unit 121. These cutouts 34 may also be provided for preventing the flange portion 13 of one unit from being attracted magnetically by magnetic forces of the encoder 10 of the other unit, when these two units are placed one over the other so that they can be oriented in one particular direction.

In any of the encoder-equipped sealing devices 1 according to the embodiments shown in FIGS. 2 and 3, the elastic element 16 may be formed to have a thickness that becomes greater toward thickened part 20, starting at a position corresponding to a point at which the right side of rolling element 124 in FIG. 6 is located nearest to the encoder-equipped sealing device 1 and extending toward a direction of an outer diameter as indicated by arrow 125, when the encoder-equipped sealing device is mounted on the bearing unit 121 as shown in FIG. 6. In this way, the elastic element 16 can have a protrusion (thickness W) that is sufficient to prevent magnetic cohesion due to magnetic attraction of the encoder 10 from occurring between the two units 1, 1 that are placed adjacently each other.

Possible Industrial Applications of the Invention

Several units, such as two units, of the encoder-equipped sealing device according to any of the embodiments of the present invention may be stored in a mounting magazine such that they are placed adjacently each other and such that they can be oriented in one particular direction, before they are actually mounted onto a bearing unit. One of the units can be removed from the mounting magazine by simply sliding the one unit vertically or horizontally relative to the other unit, and then can be mechanically mounted onto the bearing unit without causing any problem or inconvenience in handling the units. The present invention enables this mounting to occur with drastically increased reliability, and thus may be used advantageously in such applications as a manufacturing process for bearing units on automotive vehicle wheels.

What is claimed is:

1. An encoder-equipped sealing device comprising:
a first seal member facing in a first direction, and a second seal member facing in an opposite second direction, wherein
(i) each of said first and second seal members include a reinforcing ring having an L-shaped cross section defined by a cylindrical portion and a flange portion extending from one end of said cylindrical portion in a direction perpendicular to said cylindrical portion,
(ii) said first seal member includes an elastic seal supported by said reinforcing ring of said first seal member, with said elastic seal extending toward said second seal member such that two seal portions are formed between said elastic seal and said second seal member, with one of said two seal portions being formed between said elastic seal and said flange portion of said second seal member, and the other of said two seal portions being formed between said elastic seal and said cylindrical portion of said second seal member,
(iii) one of said first and second seal members includes an encoder on a side of said flange portion of said reinforcing ring of said one of said first and second seal members that faces away from the other of said first and second seal members, and
(iv) said other of said first and second seal members includes an elastic element supported by said flange portion of said reinforcing ring of said other of said first and second seal members, with said elastic element having a thickness of at least 0.7 mm and being on a side of said flange portion of said reinforcing ring of said other of said first and second seal members that faces away from said one of said first and second seal members.

2. The encoder-equipped sealing device according to claim 1, wherein
said elastic element extends over said side of said flange portion of said reinforcing ring of said other of said first and second seal members for an entire length of said side of said flange portion.

3. The encoder-equipped sealing device according to claim 1, wherein
said elastic element has a thickness that increases from one end of said side of said flange portion of said reinforcing ring of said other of said first and second seal members to another end of said side of said flange portion, such that said elastic element has a thicker part, with said thicker part having said thickness of at least 0.7 mm,
such that when the encoder-equipped sealing device and another encoder-equipped sealing device are adjacent one another, and oriented in a particular direction, said thicker portion spaces said flange portion of said reinforcing ring of said other of said first and second seal members from the encoder of the another encoder-equipped sealing device.

4. The encoder-equipped sealing device according to claim 3, wherein
said elastic element extends over said side of said flange portion of said reinforcing ring of said other of said first and second seal members for an entire length of said side of said flange portion.

5. The encoder-equipped sealing device according to claim 4, wherein
said thicker part is positioned so as to correspond to a top end of the encoder of the another encoder-equipped sealing device, when the encoder-equipped sealing device and the another encoder-equipped sealing device are adjacent one another and oriented in the particular direction.

6. The encoder-equipped sealing device according to claim 4, wherein
an outer surface of said elastic element is smooth and slanted.

7. The encoder-equipped sealing device according to claim 3, wherein
said thicker part is positioned so as to correspond to a top end of the encoder of the another encoder-equipped sealing device, when the encoder-equipped sealing device and the another encoder-equipped sealing device are adjacent one another and oriented in the particular direction.

8. The encoder-equipped sealing device according to claim 3, wherein
an outer surface of said elastic element is smooth and slanted.

9. The encoder-equipped sealing device according to claim 3, wherein said elastic element extends over said side of said flange portion of said reinforcing ring of said other of said first and second seal members for an entire length of said side of said flange portion, and projects beyond said another end of said side of said flange portion.

10. The encoder-equipped sealing device according to claim 9, wherein
an outer surface of said elastic element is smooth and slanted.

11. The encoder-equipped sealing device according to claim 10, wherein
that portion of said elastic element that projects beyond said another end of said side of said flange portion corresponds to a greatest thickness of said elastic element and functions as a projecting ring having elasticity.

12. The encoder-equipped sealing device according to claim 10, wherein
said flange portion of said reinforcing ring of said other of said first and second seal members has cutouts.

13. The encoder-equipped sealing device according to claim 9, wherein
that portion of said elastic element that projects beyond said another end of said side of said flange portion corresponds to a greatest thickness of said elastic element and functions as a projecting ring having elasticity.

14. The encoder-equipped sealing device according to claim 9, wherein
said flange portion of said reinforcing ring of said other of said first and second seal members has cutouts.

15. The encoder-equipped sealing device according to claim 1, wherein
when the encoder-equipped sealing device and another encoder-equipped sealing device are adjacent one another, and oriented in a particular direction, a portion of said elastic element having said thickness of at least 0.7 mm corresponds to a top end of the encoder of the another encoder-equipped sealing device.

16. An encoder-equipped sealing device comprising:
a first seal member facing in a first direction, and a second seal member facing in an opposite second direction, wherein
(i) each of said first and second seal members include a reinforcing ring having an L-shaped cross section defined by a cylindrical portion and a flange portion extending from one end of said cylindrical portion in a direction perpendicular to said cylindrical portion,
(ii) said first seal member includes an elastic seal supported by said reinforcing ring of said first seal member, with said elastic seal extending toward said second seal member such that two seal portions are formed between said elastic seal and said second seal member, with one of said two seal portions being formed between said elastic seal and said flange portion of said second seal member, and the other of said two seal portions being formed between said elastic seal and said cylindrical portion of said second seal member,
(iii) one of said first and second seal members includes an elastic element on a side of said flange portion of said reinforcing ring of said one of said first and second seal members that faces away from the other of said first and second seal members, with said elastic element having an end, and
(iv) said other of said first and second seal members includes an encoder on a side of said flange portion of said reinforcing ring of said other of said first and second seal members that faces away from said one of said first and second seal members, with said encoder having an end that is generally at the same level as said end of said elastic element such that when the encoder-equipped sealing device and another encoder-equipped sealing device are adjacent one another, and oriented in a particular direction, said end of said elastic element corresponds to the end of the encoder of the another encoder-equipped sealing device and spaces said flange portion of said reinforcing ring of said one of said first and second seal members from the encoder of the another encoder-equipped sealing device.

17. The encoder-equipped sealing device according to claim 16, wherein
said end of said elastic element has a thickness of at least 0.7 mm.

18. The encoder-equipped sealing device according to claim 17, wherein
said elastic element has a thickness that increases from one end of said side of said flange portion of said reinforcing ring of said one of said first and second seal members to another end of said side of said flange portion, such that said elastic element has a thicker part, with said thicker part having said thickness of at least 0.7 mm.

19. The encoder-equipped sealing device according to claim 16, wherein
said elastic element has a thickness that increases from one end of said side of said flange portion of said reinforcing ring of said one of said first and second seal members toward another end of said side of said flange portion, such that said elastic element has a thicker part, with said thicker part including said end of said elastic element.
